(19) United States
(12) Patent Application Publication
(10) Pub. No.: US 2016/0358198 A1
(43) Pub. Date: Dec. 8, 2016

(54) Digital Customer Identification Card

(71) Applicant: Ezzat G. Bakhoum, Milton, FL (US)

(72) Inventor: Ezzat G. Bakhoum, Milton, FL (US)

(21) Appl. No.: 14/300,151

(22) Filed: Jun. 9, 2014

(51) Int. Cl. G06Q 30/02

(52) U.S. Cl. CPC G06Q 30/0226

(57) ABSTRACT

The invention is a digital customer identification card that is in essence similar to customer rewards cards that are issued by grocery stores and gas stations. The invention would eliminate the hassle created by requiring a customer to carry several paper or plastic customer rewards cards in his/her wallet or keychain. As the customer walks into a business such as a store or a gas station, software running on the customer's smart phone would automatically retrieve the geographic location of the customer and associate that geographic location with the name of the business that exists at that location. The software would then retrieve digitally stored customer identification information (such as a bar code) that was previously stored on the customer's smart phone and wirelessly transmit such information to the digital customer identification card to be displayed on its display screen. The digital customer identification card would be ideally configured as a key fob or keychain.

### SUMMARY OF THE INVENTION

The invention is a digital customer identification card that is in essence similar to customer rewards cards that are issued by grocery stores and gas stations. The digital customer identification card will be ideally a key fob or keychain with a display screen for displaying text or graphics. A second component of the invention is a software application that runs on the user's smart phone or tablet. As the user walks into a business such as a store or a gas station, the software running on the user's smart phone or tablet would automatically retrieve the geographic location of the user and associate that geographic location with the name of the business that exists at that location. The software would then retrieve digitally stored customer identification information that is stored on the user's phone or tablet and wirelessly transmit such information to the key fob or keychain to be displayed on its display screen. The customer identification information would normally be a bar code. However, simple text or a graphic to identify the customer can also be used. The business would then use such information to identify and reward the customer. Typically, the business would scan a bar code that gets displayed on the customer's key fob or keychain. But if the information displayed is text or a graphic that cannot be scanned, then the business would then enter such information manually into their computer system.

In summary, the digital customer identification card and method disclosed in this application would be a very convenient way for identifying and rewarding a customer, without the hassle created by requiring the customer to carry several paper or plastic customer rewards cards in his/her wallet or keychain.

### BRIEF DESCRIPTION OF THE DRAWINGS

FIG. 1 is a sketch of the preferred embodiment of the present invention. The figure shows a smart digital accessory attached to a keychain. The accessory features a Liquid Crystal Display (LCD) or Electrophoretic Paper (E-paper) display for displaying text or graphics. The accessory is constantly communicating with a smart phone or tablet that is placed in its vicinity (such as iPhone, Android phone, iPad, etc). Normally, the accessory would display a bar code, as shown, to identify the customer who owns the accessory.

FIG. 2 is a sketch of the same invention shown in FIG. 1, with two added features: a Universal Serial Bus (USB) interface which allows the user to access memory storage inside the smart accessory; and a tactile button that allows the user to transmit notifications back to the smart phone or tablet (e.g. a button that functions like the panic button on most other key fobs).

FIG. 3 is a flowchart that illustrates how the software that runs on the user's smart phone or tablet (the second component of the invention) works.

### DETAILED DESCRIPTION OF THE INVENTION, AND PREFERRED EMBODIMENTS THEREOF

The present invention is a two-component digital system that is designed to eliminate the hassle created by requiring a customer to carry several paper or plastic customer identification cards (a.k.a. rewards cards) in his/her wallet or keychain. The first component is a “digital customer identification card”, which is essentially a key fob or a keychain with a display screen for displaying text or graphics. The second component of the invention is a software application that runs on the user's smart phone or tablet. As the user walks into a business such as a store or a gas station, the software running on his/her phone or tablet would automatically retrieve the geographic location of the user and associate that geographic location with the name of the business. The software would then retrieve digitally stored customer identification information that is stored on the user's phone or tablet (such as a bar code that identifies the user) and wirelessly transmit such information to the key fob or keychain to be displayed on its display screen. As indicated, the customer identification information would normally be a bar code; however, simple text or graphics can also be used. The business would then use the information displayed on the “digital customer identification card” to identify and reward the customer. Typically, the business would scan the bar code that gets displayed on the device; but if the information displayed is text or a graphic that cannot be scanned, then the business would then enter such information manually into their computer system. The described digital customer identification card and method would then eliminate the need to carry several paper or plastic customer rewards cards all the time.

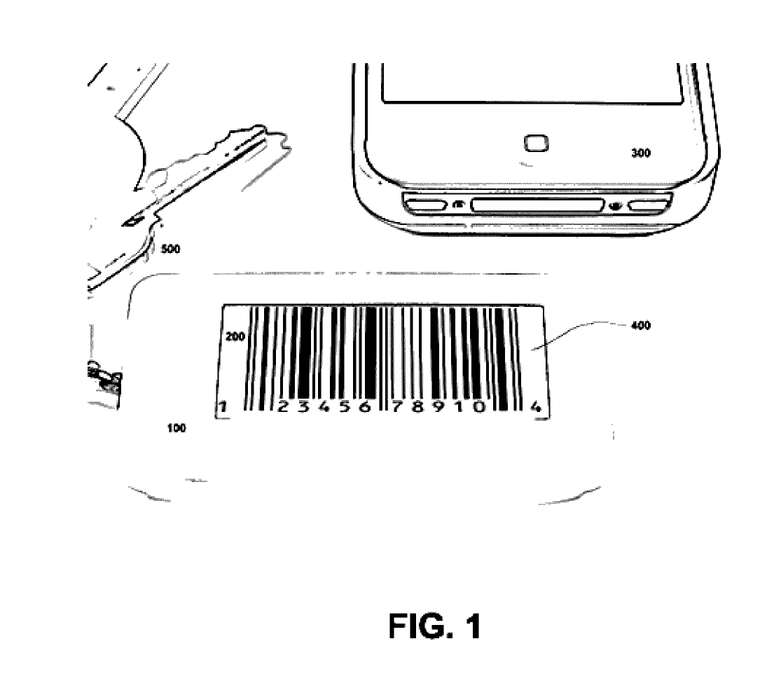

Reference is now made to the drawings. FIG. 1 shows a digital customer identification card (100) with a display screen (200) that may be a Liquid Crystal Display (LCD) or Electrophoretic Paper (E-paper) display. The E-paper display is preferred in this application because it can be easily scanned by automated laser scanners in stores. The digital customer identification card would normally operate in the vicinity of a smart phone or tablet (300) and would communicate with the smart phone or tablet via Bluetooth (a wireless protocol). As the figure shows, the smart phone or tablet would automatically transmit a bar code (400) that identifies the user to be displayed on the display screen (200). The digital customer identification device would preferably be constructed and arranged as a key fob, as shown, such that it can be attached to a keychain (500).

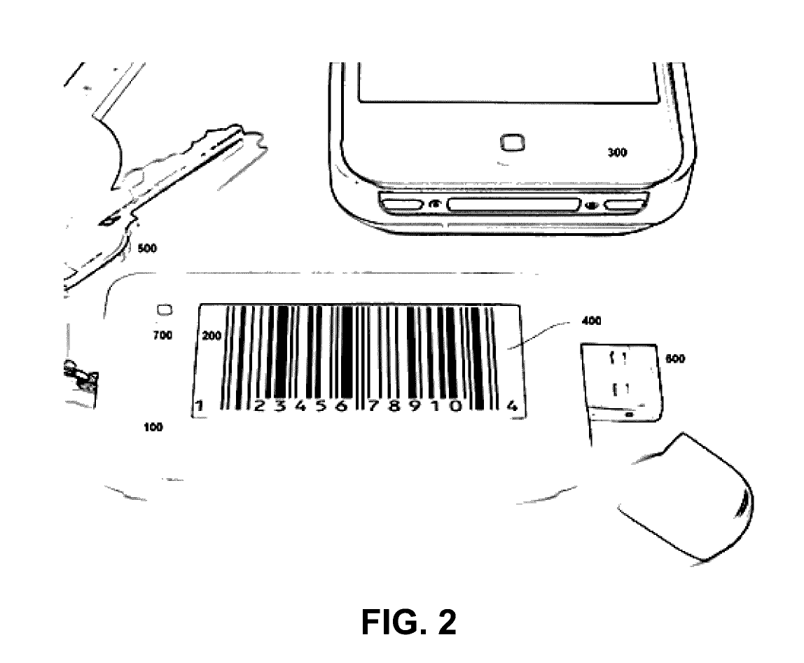

FIG. 2 shows the same elements present in FIG. 1, with two added features:
(a) A Universal Serial Bus (USB) interface (600) that would allow a computer to be connected to the device (100) in order to access a memory storage module inside the device. In this manner, the device can also serve as a USB Flash Drive.
(b) A tactile button (700) that can be used for additional user interactivity (this can be for example a paging button that can send an alert or paging signal to the smart phone).

Another feature that may be present in the device (100) is an audio buzzer or a small vibration motor for allowing the user's phone or tablet to send a paging signal to the device (such a feature would be embedded in the circuitry inside the device and therefore is not shown in FIG. 2).

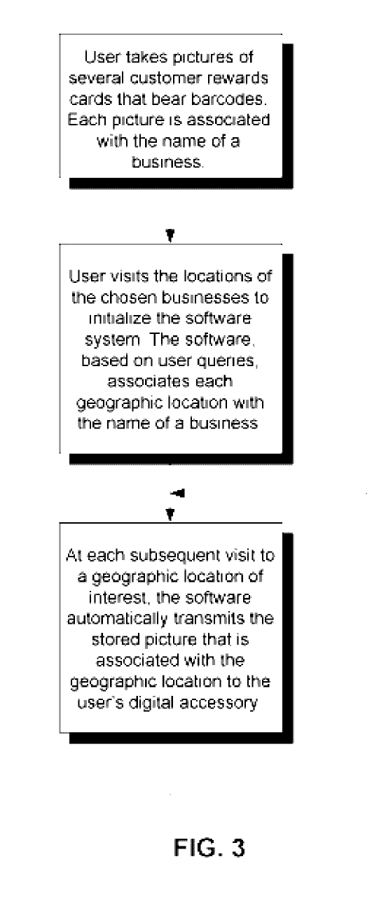

FIG. 3 shows the functionality that would be present in the software application that runs on the user's smart phone or tablet. Three main functions must be present in the software:
a) Through software control, the user takes pictures with his/her smart phone or tablet of several customer rewards cards that bear barcodes. Each picture gets associated with the name of a business (e.g. Picture #1, bearing the first barcode, gets associated with Super Foods grocery store). It is also possible that the pictures may be downloaded from the internet instead of being taken with the camera of the smart phone or tablet.
b) The user visits the locations of the chosen businesses to initialize the software system. The software, based on user queries, associates each geographic location of interest with the name of a business (e.g. 1234 Grand Avenue is associated with the Super Foods grocery store).
c) At each subsequent visit to a geographic location of interest, the software automatically transmits via Bluetooth the stored picture that is associated with that geographic location to the user's digital accessory, or the digital customer identification card (e.g. upon identifying the geographic location as 1234 Grand Avenue, Picture #1, bearing the first barcode, gets transmitted and is displayed on the screen of the digital accessory).

The digital customer identification card described above may be equipped with a rechargeable or non-rechargeable battery. In addition, if equipped with internal Flash memory as described, it can feature a variety of USB connectors for interfacing to said memory (such as Micro USB, USB 2.0, USB 3.0, etc). Finally, while the device has been described as a key fob or keychain, it will be recognized by those skilled in the art that the device can be constructed and configured in a wide variety of mechanical shapes and structures. The invention, therefore, is intended to encompass all such changes, variations, and alternatives, within its scope.

What is claimed is:

1. A digital system comprising:
a) Software that runs on a smart phone or tablet for automatically recognizing the geographic location of said smart phone or tablet and for retrieving digitally stored information pertinent to that location;
b) A digital accessory for communicating with said software that runs on a smart phone or tablet; said digital accessory comprising wireless communication means and a display screen for displaying text or graphics;
c) Functionality within said digital accessory and said software that runs on a smart phone or tablet for transferring said digitally stored information to the digital accessory and for displaying such information on its display screen.

2. A system according to claim 1, wherein the digital accessory is constructed and configured as a key fob, keychain, or keychain attachment.

3. A system according to claim 1, wherein the digitally stored information is a bar code.

4. A system according to claim 1, wherein the digitally stored information is text, a graphic, or a combination of text and graphics.

5. A system according to claim 1, wherein the digital accessory comprises an audio or vibrational notification mechanism.

6. A system according to claim 1, wherein the digital accessory comprises memory storage that is provided via Universal Serial Bus interface.

7. A system according to claim 1, wherein the digital accessory further comprises a tactile button that can be used for transmitting a signal from the accessory to said smart phone or tablet.

8. A digital system and method for recognizing customers, comprising:
a) Software that runs on a smart phone or tablet for automatically recognizing the geographic location of said smart phone or tablet, associating said geographic location with a business, and for retrieving digitally stored customer identification information pertinent to that business;
b) A digital accessory for communicating with said software that runs on a smart phone or tablet; said digital accessory comprising wireless communication means and a display screen for displaying text or graphics;
c) Functionality within said digital accessory and said software that runs on a smart phone or tablet for transferring said digitally stored customer identification information to the digital accessory and for displaying such information on its display screen for customer identification.

9. A system according to claim 8, wherein the digital accessory is constructed and configured as a key fob, keychain, or keychain attachment.

10. A system according to claim 8, wherein the digitally stored customer identification information is a bar code.

11. A system according to claim 8, wherein the digitally stored customer identification information is text, a graphic, or a combination of text and graphics.

12. A system according to claim 8, constructed and arranged as a digital customer identification card.

13. A system according to claim 8, wherein the digital accessory comprises memory storage that is provided via Universal Serial Bus interface.

14. A system according to claim 8, wherein the digital accessory comprises an audio or vibrational notification mechanism.

15. A digital accessory according to claim 8, wherein the digital accessory further comprises a tactile button that can be used for transmitting a signal from the accessory to said smart phone or tablet.

16. A method for presenting a customer's personal identifying information to a business, comprising the steps of:
a) downloading or photographing a business reward card with a smart phone or tablet;
b) associating said photograph or download with the name of a business;
c) visiting the location of said business, allowing a software application to retrieve its geographic location, and associating said geographic location with the name of said business;
d) automatically retrieving said photograph or download of said reward card upon subsequent visits to the same business wherein said software application automatically associates the geographic location of the customer with said business name.
